(19) United States
(12) Patent Application Publication
(10) Pub. No.: US 2012/0266059 A1
(43) Pub. Date: Oct. 18, 2012

(54) NETWORKED FINANCIAL PROCESSING SYSTEM

(75) Inventors: Patrick ABELA, London (GB); Alex MIFSUD, London (GB)

(73) Assignee: IXARIS SYSTEMS LIMITED

(21) Appl. No.: 13/253,670

(22) Filed: Oct. 5, 2011

Related U.S. Application Data
(60) Provisional application No. 61/390,105, filed on Oct. 5, 2010.

(51) Int. Cl. G06F 15/16; G06F 17/00

(52) U.S. Cl. 715/234; 709/217

(57) ABSTRACT

In one embodiment, a networked computer system provides regulated financial services from a regulated computer system in conjunction with unregulated content from an unregulated computer system. A user's device is redirected from the unregulated computer system to the regulated computer system, and data representing at least one page to be rendered to the user is transferred from the unregulated computer system to the regulated computer system. The regulated computer system adds regulated content to the data from the unregulated computer system and serves the data to the user's device for rendering.

### RELATED APPLICATIONS

This application claims priority to U.S. Provisional Application No. 61/390,105 filed Oct. 5, 2010, and entitled “NETWORKED FINANCIAL PROCESSING SYSTEM,” the contents of which are herein incorporated by reference in its entirety.

### BACKGROUND

Methods and systems for providing financial services via a networked computer system are disclosed.

The internet has become an effective medium for the delivery of financial services. Online financial services cover a plethora of financial operations ranging from the online provisioning of an account to the management of financial instruments such as virtual and physical cards, to facilities for depositing, transferring and spending online. Each bank is expected to have an online banking facility to allow its users to do online account management. For vendors, commerce conducted via the Internet has become a very significant channel for the sale of goods and services, worldwide.

The provision of any financial service, whether online or offline, whether provided by a financial institution or by a website, is a tightly-regulated activity in terms of the companies that are permitted to provide the service, the technical setup required to ensure secure management of financial data, as well as operational facilities required to ensure compliance with anti-money laundering rules and other applicable regulations. Financial institutions require the applicable licences to be able to provide their financial services. Similarly vendors that process online payments are required to comply with strict regulations of how such payments are technically managed and operated.

For websites that would like to accept online payments or websites that would like to start providing financial services beyond plain online ecommerce through their site, the complexity and expense of ensuring compliance could mean that it is not practical to provide and operate their own financial service. Such websites therefore utilise third-party payment processing providers to process payments and provide other financial services.

Although using a third-party provider is an effective way of adding financial services to a website, it also places restrictions on the user experience and branding of the system. In conventional systems, users are redirected to a licensed financial service providers website to complete the payment steps and the user experience for that part of the process is governed by the payment provider, not the website. There is therefore a discontinuity in user experience. Also, the appearance of the payment provider's website will be different to the website, thereby breaking the branding of the overall process, leading to a weakening of the website's brand.

Various solutions have been proposed to provide a limited customisation of the financial services company's system to reduce the differences, but it is still immediately apparent to users that parts of the system are provided by a third party and the overall user experience is diminished. Presenting an interface which combines website content and payment information is limited by technical challenges involved when merging decoupled interfaces and sessions hosted across two different sites—part of the process is hosted and managed by the website while the payment part is hosted and managed directly by the payment provider to ensure compliance with financial regulations. There is therefore a requirement for a system to allow websites to provide a consistent user experience throughout the process of interacting with a website, while maintaining compliance with all relevant regulations.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

There is provided a method of providing financial services functionality via a networked computer system, comprising receiving a request from a user's device via a network at an unregulated computer system for access to financial service functionality, transmitting a redirection instruction to the user's device, receiving a request at a regulated computer system from the user's device, the request being transmitted from the user's device in response to the redirection instruction, transferring data from the unregulated computer system to the regulated computer system, the data including a definition of content and markers for the insertion of content by the regulated computer system, processing the data at the regulated computer system to add content as indicated by the markers, and transmitting the processed data to the user's device for rendering of the data for display on that device.

The redirection instruction may include identification information relating to the user's device's interaction with the unregulated computer system.

The data transmitted from the unregulated computer system to the regulated computer system may include the identification information.

The markers may be markup language tags.

The tags may describe the appearance of the rendered data.

The tags may describe an interaction process between the user and the regulated computer system.

The method may further comprise the step of transmitting a redirection instruction from the regulated computer system to the user's device, to redirect the user's device to the unregulated computer system.

The markers may relate to the provision of financial services to the user via the regulated computer system and the user's device.

The method may further comprise receiving further requests from the user's device following interaction of the user with the displayed content.

The method may further comprise making selected information on the user's device's interaction with the regulated computer system available to the unregulated computer system.

The information may be identified by the identification information.

There is also provided a method of providing financial services functionality via a networked computer system, comprising receiving a request at a regulated computer system from a user's device via a network for a page, the request including identification information; receiving from an unregulated computer system data describing the page, the data including markers for replacement by content from the regulated computer system, processing the data to add content as indicated by the markers, and transmitting the processed data to the user's device for rendering of the data for display on that device.

The request may be transmitted by the user's device in response to a redirection instruction from the unregulated computer system.

The markers may be markup language tags.

The tags may describe the appearance of the rendered data.

The tags may describe an interaction process between the user and the regulated computer system.

The method may further comprise the step of transmitting a redirection instruction from the regulated computer system to the user's device, to redirect the user's device to the unregulated computer system.

The markers may relate to the provision of financial services to the user via the regulated computer system and the users device.

The method may further comprise receiving further requests at the regulated computer system from the user's device following interaction of the user with the displayed content.

The method may further comprise making selected information on the user's device's interaction with the regulated computer system available to the unregulated computer system.

The information may be identified by the identification information.

There is also provided a method of providing financial services functionality via a networked computer system, comprising receiving a request from a user's device to access financial service functionality, transmitting a redirection instruction to the user's device to redirect that device to a regulated computer system to provide access to the functionality, and transferring to the regulated computer system data including a definition of content and markers for the insertion of content by the regulated computer system.

The redirection instruction may include identification information relating to the users device's interaction with the unregulated computer system.

The data may be transmitted from the unregulated computer system to the regulated computer system includes the identification information.

The markers may be markup language tags.

The tags may describe the appearance of the rendered data.

The tags may describe an interaction process between the user and the regulated computer system.

The markers may relate to the provision of financial services to the user via the regulated computer system and the users device.

The method may further comprise the unregulated computer system accessing selected information on the user's device's interaction with the regulated computer system, which information is stored by the regulated computer system.

The information may be identified by the identification information.

A networked computer system for providing regulated financial services from a regulated computer system in conjunction with unregulated content from an unregulated computer system. A user's device is redirected from the unregulated computer system to the regulated computer system, and data representing at least one page to be rendered to the user is transferred from the unregulated computer system to the regulated computer system. The regulated computer system adds regulated content to the data from the unregulated computer system and serves the data to the user's device for rendering.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a system for providing internet-based financial services;

FIG. 2 shows a method of providing internet-based financial services;

FIG. 3 shows a method of providing internet-based financial services;

FIGS. 4a and 4b shows a flow chart of a process described by a tag;

FIGS. 5 to 8 show exemplary screen sections rendered according to tags;

FIG. 9 shows a system block diagram of a payment provider computer system, according to an embodiment;

FIG. 10 shows a system block diagram of a website computer system, according to an embodiment;

FIGS. 11a and 11b shows a flow chart of a process flow for EWallett management by the end-user, according to an embodiment; and

FIGS. 12a and 12b shows a flow chart of a process flow for financial instrument management by the end-user, according to an embodiment.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

As noted above, the separation of sources of pages between a website and a financial services provider leads to a reduction in the consistency of the user experience and appearance of the pages.

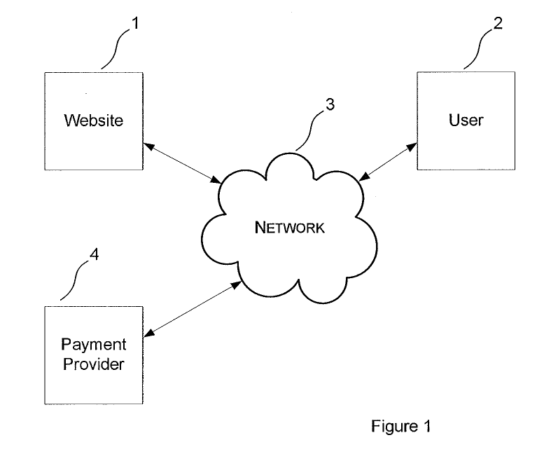

FIG. 1 shows a schematic diagram of a system to allow the close integration of a payment service into a website to provide a seamless user experience. A website is accessible at a computer system 1. A user may interact with the website using computer 2, via network 3, which is typically the internet. A financial services' computer system 4 is also accessible via network 3, and can be in communication with both the website system 1 and the user's computer 2. These communications allow the provision of financial services via an interface which appears integrated with the remainder of the website. In a particular example, which will be described in more detail below, the website is an internet vendor's website, and the financial services are the provision of a payment system for paying for goods purchased on the vendor's website. This is not intended to limit the disclosure to only that service, but is purely a single example used for clarity.

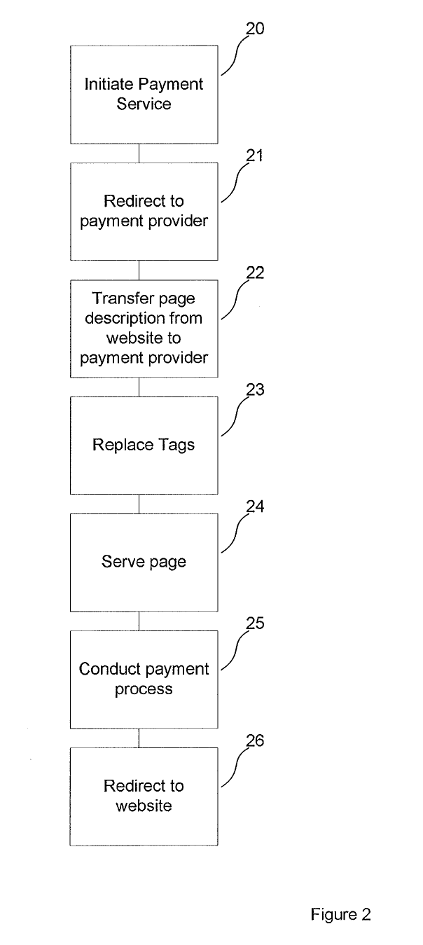

FIG. 2 shows a flow diagram illustrating the steps of a payment process using the system of FIG. 1, for an example in which the financial services provider referred to above provides payment services.

At step 20 the user takes an action on the website (for instance, clicks a button or a link) to indicate they wish to initiate a payment or a payment-related interaction.

At step 21 the user's computer 2 is redirected to an address at the payment provider's computer system 4. At step 22 the payment provider's system 4 receives a description of a web page from the website system 1, which description includes tags to indicate the surrounding context, the location, the appearance, the content and the functionality of a payment processing section of the page. The payment processing section is to be provided by the payment provider.

At step 23 the payment provider's system 4 replaces the tags with the content referenced by those tags, and at step 24 serves the page to the user's computer 2. Since the web page has been defined by the website system, the appearance of the page is consistent with that of the other parts of the website. The only inconsistency that may be seen by the user is that the URL from which the page is served will have changed from that of the website to that of the payment provider. However, even that change can be mitigated by selecting an appropriate URL customised for each website. For example, for a loyalty scheme trading at URL www.myvouchers.com, the payment provider may utilise a URL such as myvouchers.opnpayments.com, where the ‘myvouchers’ part is replaced by an appropriate name for each website.

At step 25 the user proceeds through the payment process, with the steps and appearance being defined by the tags included in the page received at step 23. However, although the content and appearance (within certain restrictions required according to regulatory rules) are defined by the website 1, the interaction is entirely between the user's computer 2 and the payment provider's system 4. The security provisions of the payment provider are therefore not compromised, and the website has no access to the data exchanged between the user and the payment provider. The regulatory obligations of the payment provider are therefore not affected by utilisation of this system.

At step 26 the payment or payment-related interaction concludes and the user's computer 2 is redirected back to the website's system 1 for the completion of any post-payment activity; for example the presentation of a confirmation on the website.

The system of FIG. 1 and the method of FIG. 2 thereby provide a means by which payment sections of a website, provided by a third party, can be customised by the website owner to ensure a consistent user experience and consistent branding across all parts of the website. This is achieved utilising a first system for providing unregulated content of a website, and a second system providing regulated content. The first, unregulated, system provides content and markers to the second computer system which replaces the markers with regulated content and serves the combined page to users. The term unregulated system is used to refer to the system providing the website content and non-financial services functionality. The term regulated system is used to refer to the system providing the content and processes related to the financial services. The terms do not imply any particular physical attributes, but only that the regulated system is configured and operated in such a way as to comply with regulations permitting the offering of the financial services.

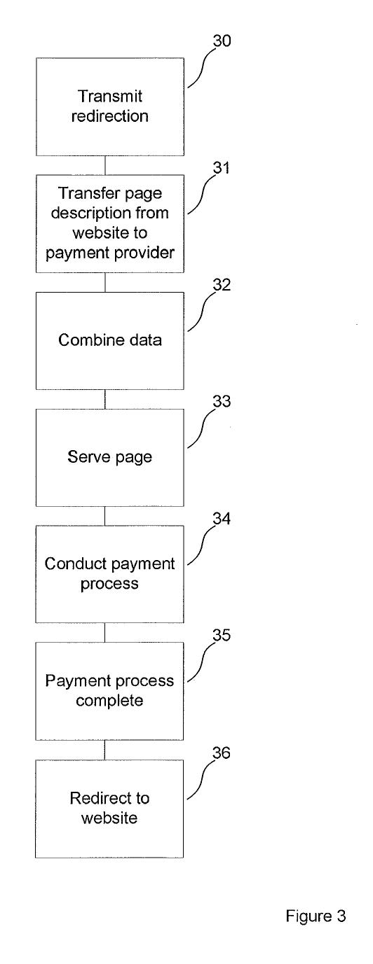

FIG. 3 shows a more detailed view of the method steps conducted between the website system and the payment provider's system to facilitate the payment interaction once the user has selected a payment function.

At block 30 the website's system transmits the redirection instructions to the user's computer, which instruction includes one or more name-value pair identifiers. Those identifiers may be utilised for purposes including identifying the website that has forwarded the user to the payment provider, defining a unique reference identifier which allows the website to track the referral on the payment provider's system, passing user information available on the website system to the payment provider (e.g. registration information which is then used to prefill a registration form in the payment process section), passing configuration information on the type of service that the user is to get from the payment provider when the user is forwarded onto the payment provider system, and identifying information that the payment provider is to pass back to the website when the payment provider redirects the user back to the website.

At block 31 the data representing the web page that the website requires to be displayed, including details of the payment process section of the web page, is transferred to the payment provider's system. The data may be sent by the website's system to the payment provider's system prior to, or in conjunction with, the issuing of the redirection instruction. The data could be sent by any suitable means, for example an upload to a defined location at the payment provider's system, or by email. Alternatively, when the payment provider's system receives the request from the user in response to the redirection request, the payment provider's system may request the data from the website's system. Typically the data will be in the form of a mark-up language file, for example HTML, WML, or any language applicable for the user's device, as discussed below. The details of the payment section may be included in the form of payment-provider specific mark-up tags describing the appearance and functionality of the payment process section. As will be discussed below, those tags may also provide details of the process to be followed during the payment interaction as well as the appearance of the section. The data also includes the identification information to allow the relation between the request resulting from the redirection to be matched to the data from the website. The data may also include data on the transaction, for example the amount of money to be expected.

The payment-provider specific mark-up tags may include, for example, the following configuration information defining the type of payment service to be rendered by the payment provider, covering a wide range of aspects for the service such as:—User specific information as maintained on the website (e.g. user id, name, surname, address etc), Payment interaction-specific information (e.g. amount for a financial transaction, currencies to be used for payment interaction), Information on how the payment service should be rendered visually to the end user (e.g. the language of the text to be shown to user, background color, font to be used), Information on devices on which the payment service will be rendered (e.g. specify whether payment pages are to be presented on a browser (HTML), mobile (WML) or any other markup language supported by the provider), Payment interaction risk attributes (e.g. any information which can help the payments platform to assess risk related to such payment interaction), General service information (e.g. geographies where this service should or should not be rendered), and/or Payment process workflow information (e.g. information could specify a complex process that is defined as a composition of a series of smaller processes, for example a process that is composed from a set of sub-processes where the user first logs in, then creates a virtual card financial instrument, then defines a funding instrument, and then loads funds from the registered funding instrument to the created virtual card).

When the data representing the web page is transmitted dynamically from the website's system to the payment provider's system at the time it is required, it can include live, dynamic, content and objects specific to the current interaction with the user. For example, in the case of a loyalty scheme site, the page can include full details on the number of loyalty points that the specific user has at the time of the redirection such that it is clear to the user what the link with the payment interaction is. The page presented by the payment provider's system can be configured to be identical in content, layout and style to the page that was being displayed by the website's system, with the addition of the payment section.

At block 32 the payment provider's system combines the data from the website's system with data held in the payment provider's system as instructed by the details of the payment process section included in the website's data. The combination is performed on the basis of replacing tags included by the website's system with data stored in the payment provider's system. For example, a tag could indicate where and what account balance should be presented, and that the background of that area should be blue. The payment provider's system would replace the tag with the code to present the account balance information area, and to make the background blue. Specific examples of tags and process controls are provided later in this document.

At block 33 the resulting page is served by the payment provider's system to the user's computer in response to that computer sending the redirection request. The content to be sent to the user's computer is identified by the identification information included in the redirection request.

At block 34 the payment process is conducted, with the user interaction being between the user's computer 2 and the payment provider's system 4. The steps followed by the process may be defined entirely, or in part, by the details included in the data transferred from the website's system 1 to the payment provider's system 4. The payment process is equivalent to the process conducted by existing payment systems.

After the initial redirection to the payment provider system, the content sent to the user's computer can contain further redirections which forward the user to different aspects of the payment provider system. For example, in a payment interaction involving the issuing of a virtual card, the user might first be presented with the card and then the user proceeds to a different page to load funds to that card. The process defined by the data sent by the website's system may not be a single page, but may involve a series of pages that are rendered one after the other by the payment provider's system.

An implementation is provided by utilizing payment provider specific tags which describe workflows. In response to the initial redirection, the payment provider's system replaces the tags with the first of a series of pages defined within the workflow. As the user completes the actions described in the rendered pages, the payment provider's system proceeds through the workflow rendering subsequent pages as defined by the workflow and the user's actions.

At block 35 the payment process is completed. There may be a number of outcomes of the process, for example, a payment interaction may have successfully completed, have failed, or finalisation may remain pending. At block 36 the user's computer is redirected back to the website, in a similar fashion to the redirection performed to the payment provider's site. The identification may again be utilised to identify the user and payment interaction, and thereby present a page appropriate to the progress through the system. The redirection may include information about the outcome of the payment interaction to allow the website to display appropriate content. Furthermore, the website's system may be provided with access to information on the transaction, for example via a web-interface to allow querying of information held for that website's transactions by the payment provider. The identification information discussed above may be utilised to identify the particular transaction. In addition, the payment provider can transmit a notification with an indication on the status of the payment interaction or details of the outcome of the payment interaction to the website.

In summary, the system and process outlined hereinbefore enables the coupled integration of a website with a payment provider such that a consistent user experience is presented, thereby extending the website with payment services provided by a third-party payment provider, without violating any regulatory requirements placed on that payment provider. This is achieved by the arrangement of a pair of connections from the user's computer to the website and the payment provider's system, coupled with a transfer of data representing web pages from the website's system to the payment provider's system, thereby enabling the appearance of the payment provider's system to be defined by the website. As will be appreciated, the term payment provider is only used for clarity and does not restrict the regulated computer system to being that of a payment provider.

Various optional features and variations of the general system and process will now be described.

In the above example, redirection from the website to the payment provider has been described in an automated manner. However, the visit to the payment provider's site could be separate, with the user being sent, for example by email or a web page link, a URL to visit to make the payment. The URL could include the identification details. Furthermore, in alternative embodiments the user may'visit the payment provider's site directly and manually enter identification information directly. This achieves the same effect as the redirection instruction, but decouples the processes.

Although the payment processing part of the web pages served by the payment provider's system are generated by that system, the remainder of the page is generated by the website, and proxied by the payment provider. There is therefore the potential for the website to include malicious code that is passed to the user. For example, code could be included to capture sensitive financial data that the user intends to give to the payment provider, thereby giving the website access to information that they should not receive, thus violating the payment provider's compliance for secure data management. To avoid this possibility, when receiving data from the website, the payment provider system scans that data to ensure there is no malicious content. The safety of the entire page served to the user is thus ensured as it has either been generated by the payment provider system, or has been scanned by that system.

To provide further assurance to the user, the payment provider system may insert additional content which notes certain details, provided when the payment provider agrees to provide payment services for the website, about the website's business to confirm the user has arrived at the payment provider's site from the expected source. For example, the detailed identity and business field of the website may be noted. If the user notices that this does not agree with the actual content of the website, there may be an error or malicious intent. For example, if the information added by the payment provider indicates the site to be related to voucher and loyalty services, but it was actually a site providing adult services, there is an indication that the website presence has been hijacked or is being used to malicious intent. A reporting mechanism may also be built in to the section of data presented such that users can alert the payment provider to a possible problem with one of the websites to whom they are providing services.

In a variation of the system described herein, the data representing the website may be transmitted to the payment provider in advance in the form of a template that should be used for all payment interactions. When a payment interaction is conducted the website's system transmits the identification information discussed above, and certain details of the interaction, but does not transmit the full data describing the required appearance of the page. When the payment process page is requested by the user, the template is utilised and populated with the appropriate data. This method removes the need to dynamically generate and transmit page descriptions, thereby reducing data processing and transmission requirements, but also reducing flexibility to customise the pages presented. Although they are still fully consistent with the website as they were generated by them, they are not dynamically updated and so cannot include information particular to the user's session.

Since the data representing the web page is dynamically generated by the website and payment provider's systems, the format of the data can be defined to match the device requesting it. For example, HTML may be utilised if the device is a computer, or WML if the device is a mobile device. This allows the appearance of the pages to be tailored for the device being utilised, thereby improving the user's experience. This can also be extended to the example where a pre-set template is transmitted to the payment platform in advance. Multiple templates may be transmitted for each device type and the appropriate one selected during a transaction.

The above examples have been given principally in relation to the provision of payment services during the purchase of goods or services from a vendor. However, the same principles, systems and methods described above can be employed for a range of financial transactions and payment interactions, including but not necessarily restricted to the payment stages of a purchase process. As well as payment processing, websites may also wish to provide, for example, virtual card issuing and management, management of an online ewallet account, fund transfer between accounts, group payment interactions, customised-design card issuing, and person to person fund transfers. Since the data transferred to the payment provider enables the full definition of the process, each of these can be provided for by tailoring the process to suit the particular service desired. The principles employed remain unchanged, in that a user is redirected from the website to the payment providers site, a description of the required page and process is transferred from the website to the payment provider's site, and the payment provider's system compiles the pages for serving to the user based on the transferred description, the payment interaction is conducted between the user's computer and the payment provider's system, and the user is then returned to the website.

A number of financial services that may be offered using the systems and methods described hereinbefore are described briefly below.

Virtual Wallet:—A website is able to provide functionality to allow a user to maintain a balance in a virtual wallet and to allow the user to fund that balance with various funding instruments such as cheques, cards, bank transfer and other funding methods. The payment provider takes responsibility for managing the user funds in compliance with applicable regulations.

P2P Payments: A website can allow users to do P2P transfers. The payment provider takes responsibility for managing the user funds in compliance with applicable regulations.

Virtual Card:—Through this service a website is able to allow an end-user to issue a virtual card and to allow the end-user to load funds on to the virtual card, check the balance of the card and do other card-specific operations. The virtual card can be rendered with a design as chosen by a website. The payment provider is responsible for issuing the virtual card (in compliance with regulations stipulated by card schemes such as Visa®, Mastercard® and others) as well as providing related services.

Plastic Card:—Through this service a website is able to issue a plastic card to an end user and allow users to load funds to the card as well as withdraw funds from the card from an ATM. The issued plastic card will have a design as chosen by the website (or end user). The payment provider is responsible for issuing the plastic cards (in compliance with regulations stipulated by card schemes such as Visa®, Mastercard® and other schemes) and providing the related services.

Card Controller:—Through this service a website is able to develop a service which allows one party to control and view transactions made on a card (virtual or plastic) owned and issued to another third party. Typical scenarios are cases such as when a finance department needs to track transactions done on a card issued to a company's employees. Another scenario is the case when a parent funds a card issued to their child and needs to track purchases that the child is making. The payment provider is responsible for issuing the card and providing the related services.

Referred Payments:—During a checkout process a website is able to allow a user to defer payment and to forward the payment request to a third party who are requested to pay for the purchase. One scenario is the case when a child would like to purchase an item to be paid by a parent. The payment provider is responsible of tracking a payment with a deferred purchase.

Group payments:—During a checkout process a website is able to allow a group of people to pay for a single purchase. This may be utilized to provide various purchase options. For example, the cost of the purchase may be shared amongst a group of people, a group of items may be purchased by a group of people, and tiered wholesale discounts may be provided depending upon the size of the group. The payment provider provides all of the functionality to handle the complexities of a group payment, including cases when individuals withdraw their commitment to a purchase.

In the example described previously, the user is a person accessing the website as a customer, but, particularly in the case of some of the examples of financial service immediately above, the user may be another business.

As noted previously, a mark-up language of tags may be an appropriate method of describing the content to be included by the payment provider system. The tags and their definitions would be made available to the website owner to include in their pages. Upon receipt by the payment provider's system of those tags they are rendered according to the rules associated with each tag to generating the page for the user. For example, the tags may be replaced with HTML tags for rendering by the browser, by Javascript or other code for conducting processes at the user's computer, or by images for display at the user's computer.

The tags may not only define the static appearance of a page, but may indicate a whole process to be conducted. Specific examples are given below of a particular family of tags according to an embodiment of the invention. These are given by way of example only and are not restrictive of the scope of the disclosure, nor of the representation, content, type or behaviour of tags covered by this disclosure.

In an exemplary embodiment, a first set of tags relate to the creation and management of an online financial account. For this specific embodiment, three tags may be provided to enable various aspects of this:—

EWallet—Allow a user to provision and access an online financial account with ewallet-like properties.

EWalletManager—Allow a user to manage a created account, including the possibility to change preferences

InstrumentsManager—Allow a user to manage a range of financial instruments to deposit or withdraw funds from an account.

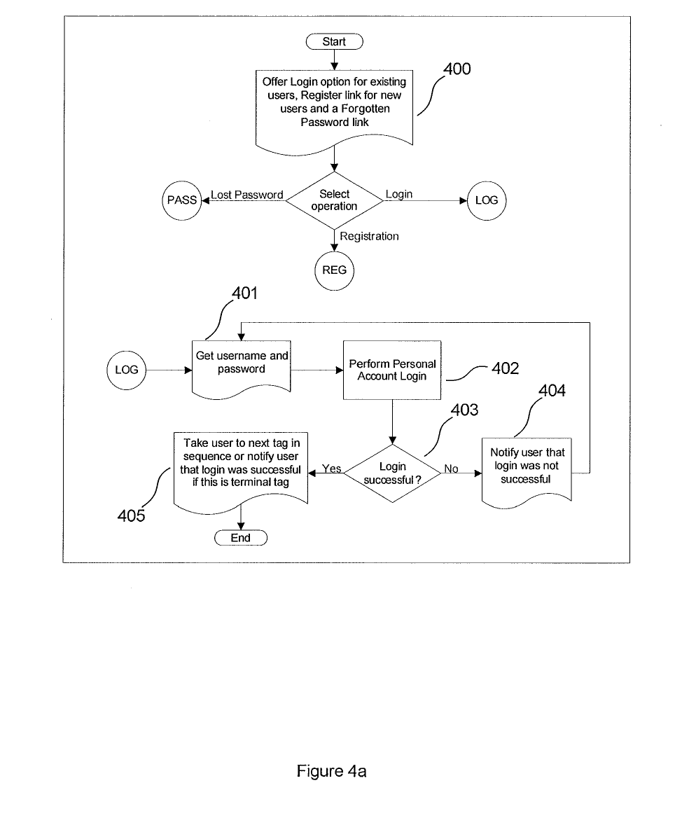

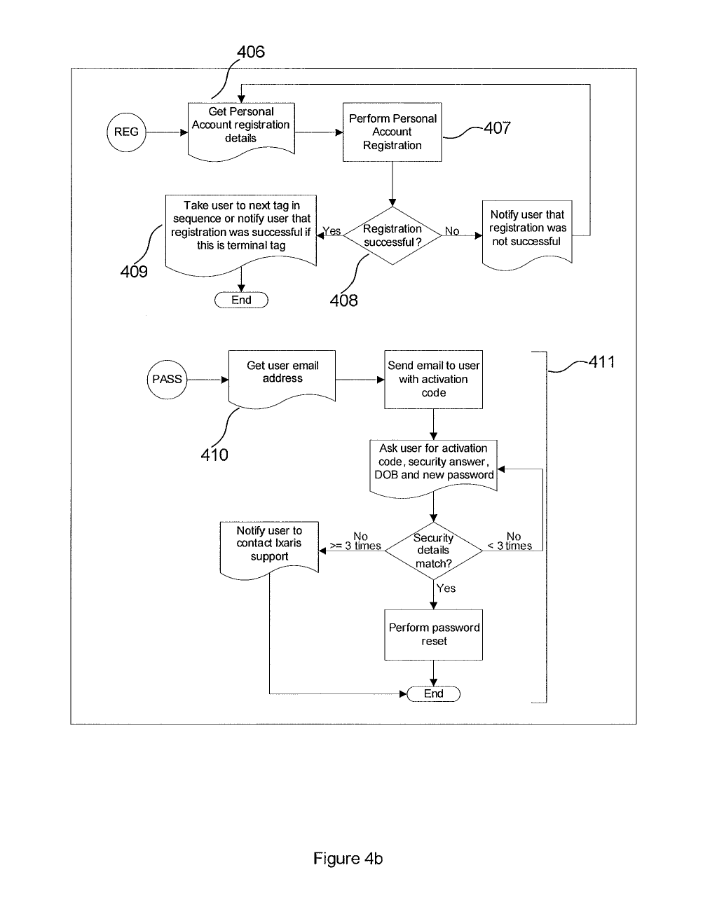

FIGS. 4a and 4b shows a set of flowcharts describing the processes defined by the EWallet tag.

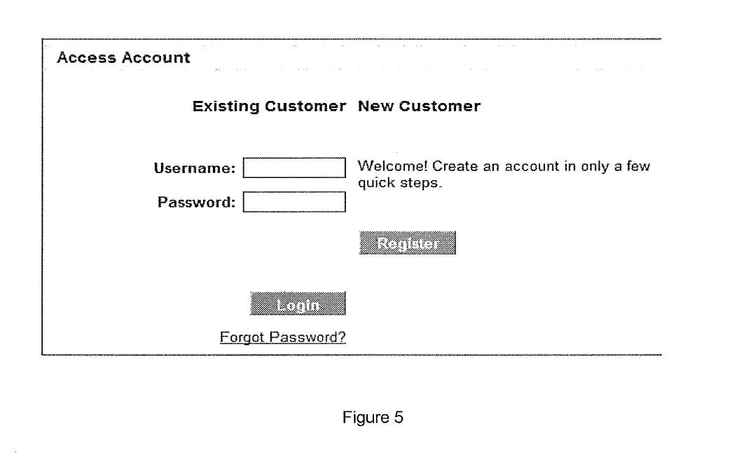

At step 40 a login screen, as shown in FIG. 5, is rendered to the user as part of the whole page defined by the data received from the website's system. The user may login, or select the register or forgotten password options. If the user logs in, the payment provider's system proceeds through steps 401 and 402 to step 403. If the log in is unsuccessful a message is rendered to the user at step 404 notifying them of the failure to log in. If the log in was successful, the payment provider proceeds to step 405, may render a message to the user notifying them of this, and then moves to the next tag in the data provided by the website's system and proceeds as defined by that tag.

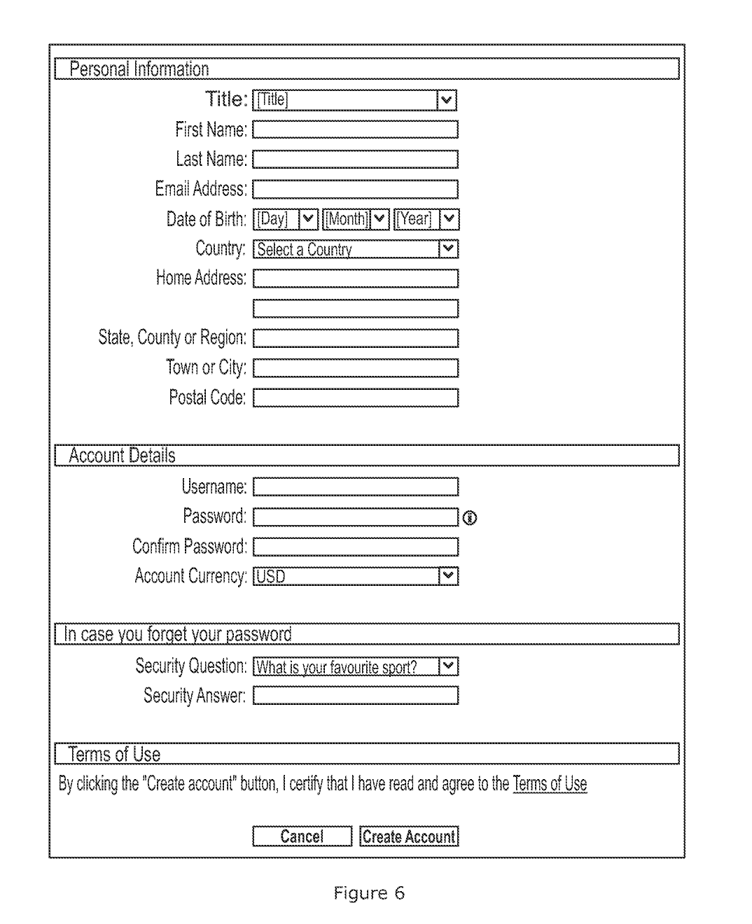

If the user selects the register option, the payment provider's system proceeds to step 406 where a screen, as shown in FIG. 6, is rendered as part of the whole page defined by the data received from the website's system. The payment provider's system then proceeds through steps 407 and 408 to register the user. Once registered, at step 409 the payment provider proceeds to the next tag in the data received from the website's system.

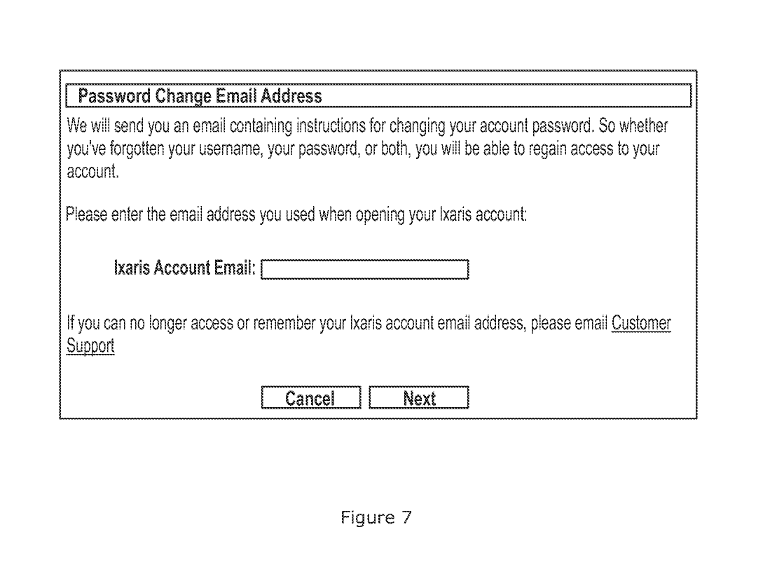

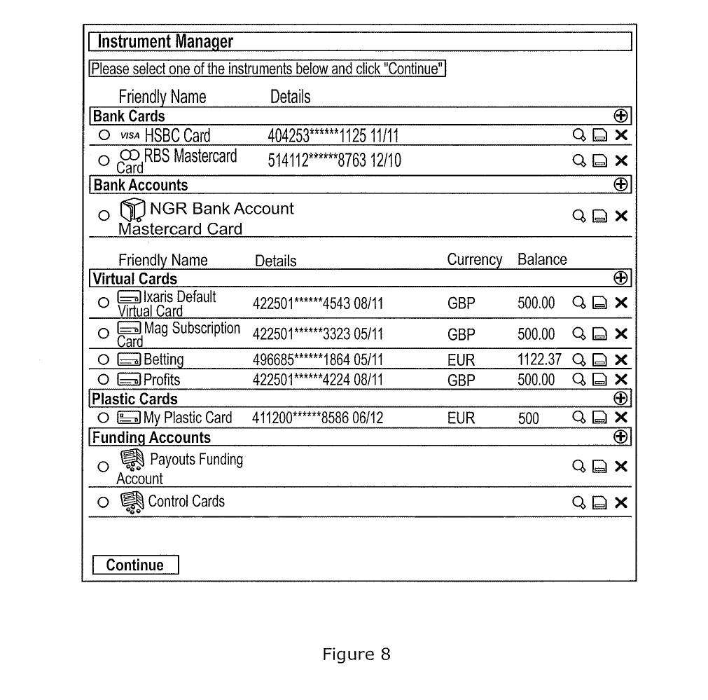

If the user selects the forgotten password option, the payment provider's system proceeds to step 410 and renders a screen, for example as shown in FIG. 7, as part of the whole page defined by the data from the website's system. The payment provider's system then proceeds through the steps 411 rendering appropriate screens at each stage.

To control the functioning of the EWallet tag a number of arguments may be provided. Table 1 below gives examples of arguments that may be provided in an exemplary implementation.

TABLE 1

| Name | Type | Description |
|---|---|---|
| websiteId | String | This identifier identifies the website that is referring |
| | | the user. This identifier is given by the payment |
| | | provider to the website owner before the website |
| | | can forward any users to the payment provider |
| websiteReferralId | String | This identifier identifies uniquely the payment |
| | | interaction referral for the website. This identifier |
| | | can subsequently be used by the website to query |
| | | the status of a referral |
| accountReferenceId | String | This identifier identifies uniquely the user that is |
| | | being referred. This identifier can subsequently be |
| | | used by the website to query the status of a referral |
| userId | String | If a value is provided for this field then it is used to |
| | | prefill the userId field for the login and registration |
| | | forms. |
| currencyOverride | Enumeration | If provided, the new account currency will not be |
| | | user-selectable but will be set to the specified |
| | | currency |
| language | Enumeration | If provided, this field specifies the language used to |
| | | render the payment interaction content |
| returnURL | String | The payment provider will forward the user to this |
| | | URL at the end of the payment interaction. |
| The following fields are | | If a value is provided for any of these fields then |
| relevant to the registration | | such values are used to prefill the corresponding |
| path and are grouped | | fields for the login and registration forms |
| together under an input field | | |
| personalDetails which | | |
| is in and of itself an optional | | |
| field. | | |
| emailAddress | | |
| title | | |
| firstName | | |
| lastName | | |
| addressLine1 | | |
| addressLine2 | | |
| city | | |
| stateCountyRegion | | |
| postalCode | | |
| country | | |
| dobDay | | |
| dobMonth | | |
| dobYear | | |
| registrationCurrenciesAllowed | Set of | Specifies the currencies to be made available to |
| | String | the user for selection |
| registrationCurrencyDefault | String | This value specifies the default currency to be |
| | | rendered visually to the user. The user can opt to |
| | | choose any other currency specified in |
| | | registrationCurrenciesAllowed |
| regCountriesAllowed | Set of | Specifies the list of allowed countries to be |
| | String | supported by the payment provider system. |
| regCountriesRestricted | Set of | Specifies the list of countries from where |
| | String | registrations are not to be accepted |
| CSS | String | A reference to the Cascading Style Sheet to be |
| | | used to render the content generated by the |
| | | payment provider. This sheet defines the visual |
| | | aspects of the content to ensure that the look and |
| | | feel of the payment section matches that of the |
| | | website |
| outputType | String | Specifies the type of device upon which the |
| | | payment provider service is to be rendered: |
| | | Accepts these values: |
| | | HTML |
| | | WML |
| | | custom |

Table 2 shows exemplary parameters that may be returned by the tag for use in subsequent tags or returned to the returnURL parameter described above.

TABLE 2

| Name | Type | Description |
|---|---|---|
| websiteReferralId | String | This identifier specifies the referral |
| | | id passed by the website in |
| | | the PayML tag |
| accountReferenceId | String | This identifier specifies the account |
| | | reference passed by the website |
| | | to identify the user uniquely. |
| status | Enumerated | Specifies the resulting status of the |
| | | payment interaction. The |
| | | returned value is one of: |
| | | SUCCESSFUL: operation |
| | | was completed successfully |
| | | FAILED: operation was not |
| | | successful PENDING: |
| | | operation is still pending |
| | | completion |
| | | ABANDONED: operation was not |
| | | completed before timeout occurred |
| errorCode | String | If status is FAILED, this field |
| | | specifies the error code of |
| | | the corresponding failure |
| errorDescription | String | If status is FAILED, this field |
| | | specifies the error description |
| | | to provide more information on |
| | | the error that occurred |

An example use of the EWallet tag that can be embedded within a website that would like to provide ewallet services to its end users is shown immediately below. The payml prefix is used to indicate that the tag is one that should be processed by the payment provider's system.

<payml:ewallet websiteId=”myVouchers.com”
websiteReferralId=”2294-3239” accountReferenceId=”appUser01”
userId=”appUser01” currencyOverride=”USD” language=”EN”
returnURL=”http://www.myvouchers.com/return.shtml”
personalDetails=”” />

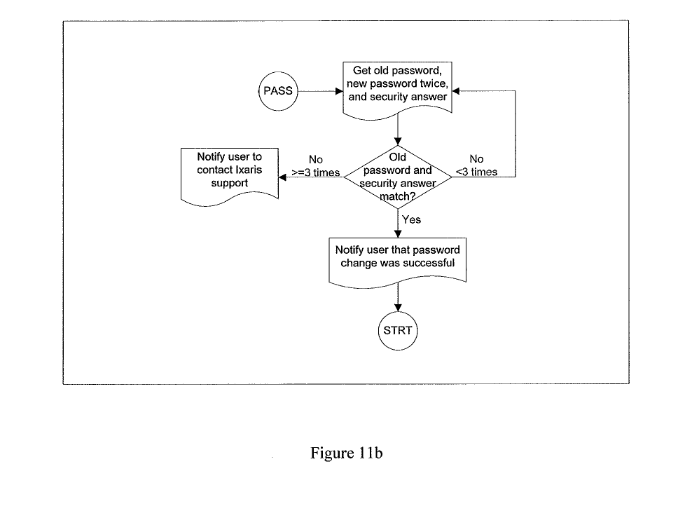

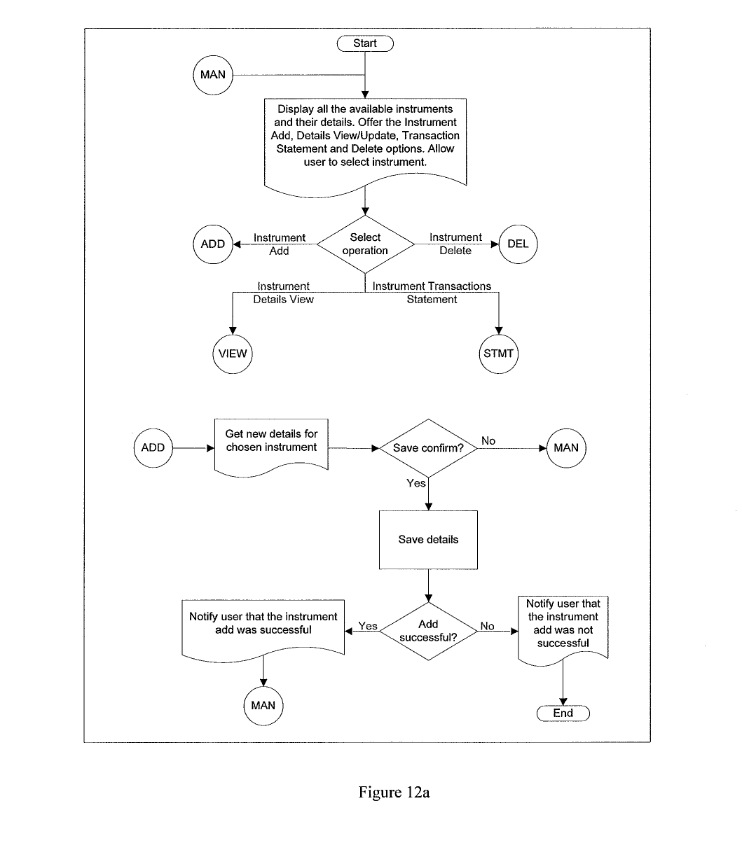

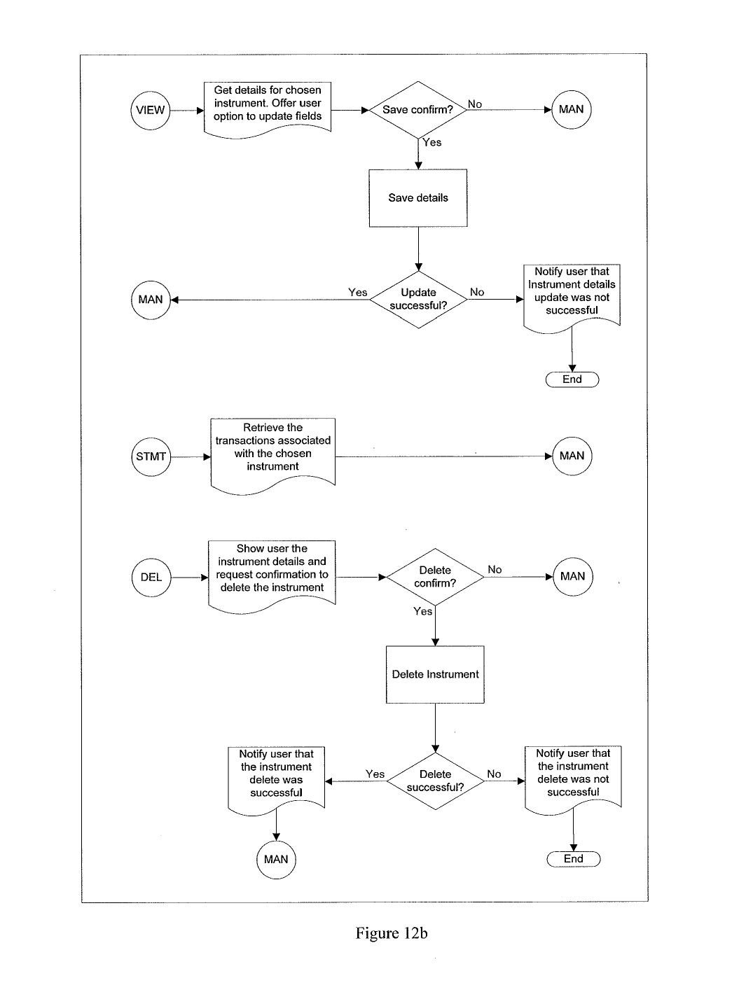

Additional examples of tags and the associated flow diagrams are shown in Appendix 1 and FIGS. 11a-11b and 12a-12b.

An additional example of a tag included in the data received from the website's system is shown immediately below.

<payml:instruments-manager websiteId=”myVouchers.com”
websiteReferralId=”2294-3240”
returnURL=”http://www.myvouchers.com/return.shtml”
selectorMode=”true” instrumentTypeAllow=”ALL”
instrumentView=”ALL”
instrumentAdd=”ALL” instrumentDelete=”ALL” viewDeleted=””
instrumentDetailsUpdate=”ALL” />

Depending upon the configuration data forwarded by the website, the payment provider will render pages which allow a user to manage financial instruments through a controlled interface. The facilities which are made available to the user (for instance the type of financial instruments which can be managed by the user from within this instruments management facility) are as defined in the configuration attributes specified in the PayML tag.

Appendix 1 at the end of this description provides a summary of an exemplary set of tags that may be utilised to provide a range of financial transaction systems according to the systems and methods described herein.

A management system may be provided to simplify the generation of the tags for inclusion in the website's data. That system may present a graphical interface with a set of options that a website developer can choose for each payment interaction process. The developer selects the options they wish to use and the system generates the tags required to implement those options. Such a system removes the need for detailed programming knowledge by the website owner, and also ensures that the tags provided to the payment provider comply with the requirements for those tags and can thus be rendered with causing errors.

The management system defines also a development environment which allows the website developer to develop, test, stage and deploy a payment service. After the service is deployed and taken into production, the website operator can operate and configure some aspects of the deployed service through such management system.

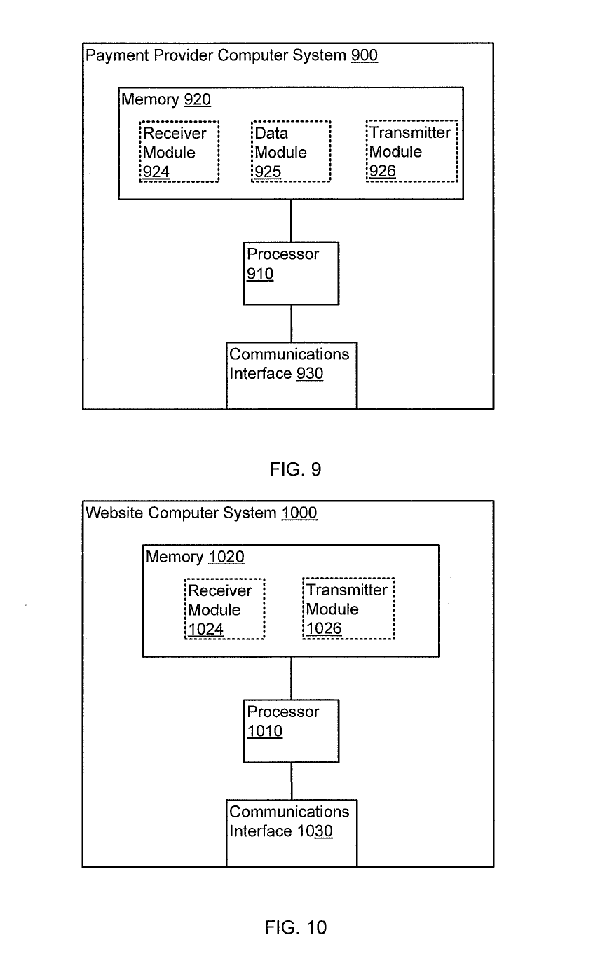

FIG. 9 is a system block diagram of a payment provider computer system 900, according to an embodiment. Payment provider computer system 900 can be similar to the payment provider computer system 4 shown in FIG. 1. Payment provider computer system 900 includes processor 910, memory 920, and communications interface 930. Processor 910 is operatively coupled to memory 920 and communications interface 930. Payment provider computer system 900 can communicate with other systems, devices and networks (such as website computer system 1, user 2 and network 3 shown in FIG. 1) via a communications interface 930.

As illustrated in FIG. 9, payment provider computer system 900 can host a receiver module 924, a data module 925 and a transmitter module 926. In other words, receiver module 924, a data module 925 and a transmitter module 926 each can be processes, applications, and/or some other software module (executing in hardware) or hardware module that is executed at payment provider computer system 900. In some embodiments, for example, instructions that implement a receiver module 924, a data module 925 and a transmitter module 926 can be stored at memory 920 and executed at processor 910.

In some embodiments, payment provider computer system 900 can be dedicated to the modules 924, 925 and 926. In other words, payment provider computer system 900 can allocate all or substantially all of its computing resources (e.g., processing capacity and memory) to the modules 924, 925 and 926. In some embodiments, payment provider computer system 900 can host other processes, applications and/or software modules in addition to the modules 924, 925 and 926. For example payment provider computer system 900 can be a general purpose compute device that hosts multiple processes, applications and/or software modules.

The receiver module 924, data module 925 and transmitter module 926 each can relate to a portion of the processes described above, for example, in reference to FIGS. 2 and 3. For example, the receiver module 924 can relate to the receiving of requests, signals or messages from the user's device or the website computer system (e.g., user device 2 and website computer system 1 shown in FIG. 1) as described in step 22 in FIG. 2. Similarly, the data module 925 can relate to the processing of data, for example, to add content based on the markers, as discussed in connection with steps 23-25 in FIG. 2. The transmitter module 926 can relate to the transmitting of data, signals or messages to the user's device or the website computer system (e.g., user device 2 and website computer system 1 shown in FIG. 1) such as the transmission of processed data to the user's device for rendering the data on the display on that user's device, as discussed in connection with step 26 of FIG. 2.

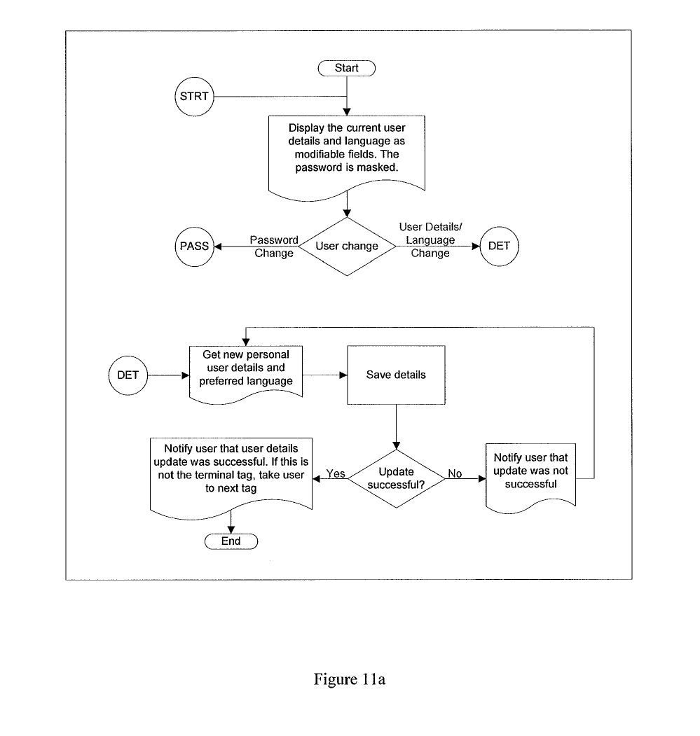

FIG. 10 is a system block diagram of a website computer system 1000, according to an embodiment. Website computer system 1000 can be similar to the website computer system 1 shown in FIG. 1. Website computer system 1000 includes processor 1010, memory 1020, and communications interface 1030. Processor 1010 is operatively coupled to memory 1020 and communications interface 1030. Website 1000 can communicate with other systems, devices and networks (such as payment provider computer system 4, user 2 and network 3 shown in FIG. 1) via a communications interface 1030.

As illustrated in FIG. 10, website system 1000 can host a receiver module 1024, and a transmitter module 1026. In other words, receiver module 1024 and a transmitter module 1026 each can be processes, applications, and/or some other software module (executing in hardware) or hardware module that is executed at website computer system 1000. In some embodiments, for example, instructions that implement a receiver module 1024 and a transmitter module 1026 can be stored at memory 1020 and executed at processor 1010.

In some embodiments, website computer system 1900 can be dedicated to the modules 1024 and 1026. In other words, website computer system 1000 can allocate all or substantially all of its computing resources (e.g., processing capacity and memory) to the modules 1024 and 1026. In some embodiments, website computer system 1000 can host other processes, applications and/or software modules in addition to the modules 1024 and 1026. For example website computer system 1000 can be a general purpose compute device that hosts multiple processes, applications and/or software modules.

The receiver module 1024, and transmitter module 1026 each can relate to a portion of the processes described above, for example, in reference to FIGS. 2 and 3. For example, the receiver module 1024 can relate to the receiving of requests, instructions, signals or messages from the user's device or the payment provider computer system (e.g., user device 2 and payment provider computer system 4 shown in FIG. 1) as described in step 26 in FIG. 2. Similarly, the transmitter module 1026 can relate to the transmitting of data, instructions, signals or messages to the user's device or the payment provider computer system (e.g., user device 2 and payment provider computer system 4 shown in FIG. 1) such as the transmission of redirection instructions to the user's device to redirect that user device to a regulated computer system or data including the markers to the regulated computer system.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants, set-top boxes and many other devices. The term ‘website’ is not intended to require that the website is related wholly or even in part to the sale of goods or services. The party identified as the website could equally operate their website or system to facilitate other transactions or services, not necessarily in return for direct payment or reward. The systems and methods described herein are therefore not restricted to conventional trading entities, but are also applicable to any party providing financial services using a third party.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media Include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

### Appendix 1—Exemplary Tag Descriptions, Parameters and Flowcharts.

1.1. payml:eWallet-Manager

A user with an eWallet (as provisioned through the ewallet tag) can be provided with various functions which would allow the user to manage the eWallet.

A website that embeds payml:eWallet-manager tag allows the user to access such functionality as an extension of the website itself. Through the method described above, the website can customize the functionality that is to be provided to the end user as well as the look and feel of such functionality.

The EWallet Manager defines these functions:
update personal user details
change preferred language
change password

The process flow for EWallet management by the end-user is shown in FIGS. 11a and 11b.

The process can be customized by the website through the following configuration data:

| Name | Type | Description |
|---|---|---|
| allowPersonalUserDetailsUpdate | Boolean | Determines whether a user is |
| | | to be allowed to update his |
| | | personal details |

This tag also accepts attributes described for <payml:ewallet>:
websiteId
websiteReferralId
accountReferenceId
returnURL
CSS
outputType

The tag returns the same output as <payml:ewallet>

1.2. payml:Instruments-Manager

A user with an eWallet can be provided with various functions which would allow the user to deposit funds and spend funds within the eWallet. This can be done through financial instruments that can be registered with the eWallet. The payment provider provides all the required services for a user to manage instruments (for example, add, remove, edit, view) as well as the possibility to issue new instruments as provided by the payment provider.

A website that embeds payml:instruments-manager tag allows the user to access such functionality as an extension of the website itself. Through the method described above, the website can customize the functionality that is to be provided to the end user as well as the look and feel of such functionality.

The Instrument Manager defines these functions:
add, register a new financial instrument
view or update a registered financial Instrument
view statement of transactions done on a specific financial instrument
remove Financial Instrument

Depending upon the payment provider capabilities, the financial instrument types that can be used to fund an e-wallet would be:
a user bank Card (Visa®, Mastercard® etc.)
a bank account (funding would take place through bank transfer)
custom loading options (funding through other payment networks such as Paypal®)

Depending upon the payment provider capabilities, the financial instrument types that can be issued for the user would be:
virtual Cards (Visa® or Mastercard®)
plastic Cards (Visa® or Mastercard®)

The process flow for financial instrument management by the end-user is shown in FIGS. 12a and 12b.

This tag requires the following configuration:

| Name | Type | Description |
|---|---|---|
| instrumentTypeSupported | Enumerated | Defines the instrument types that the website allows the |
| | | user to register with the e-wallet. Must be one of: |
| | | USER_BANK_CARD |
| | | USER_BANK_ACCOUNT |
| | | PROVIDER_VIRTUAL_CARD_VISA |
| | | PROVIDER_VIRTUAL_CARD_MASTERCARD |
| | | PROVIDER_PLASTIC_CARD_VISA |
| | | PROVIDER_PLASTIC_CARD_MASTERCARD |
| | | ALL |
| | | If this value is not specified the user is not allowed to |
| | | associate any instruments with the eWallet. |
| | | The range of instrument types supported by a payments |
| | | provider can change according to the capabilities of the |
| | | payment provider. Hence, it could be the case that new |
| | | instrument types become available after the website |
| | | embeds the PayML tag within the website (with a specific |
| | | subset of instruments available at the time of |
| | | development) |
| | | This ALL identifier specifies that if new instruments |
| | | become supported by the platform these are to be made |
| | | available automatically to the end-user |
| unsupportedInstrumentTypes | Enumerated | Defines the instrument types that should not be provided |
| | | to the end user. Must be one of: |
| | | USER_BANK_CARD |
| | | USER_BANK_ACCOUNT |
| | | PROVIDER_VIRTUAL_CARD_VISA |
| | | PROVIDER_VIRTUAL_CARD_MASTERCARD |
| | | PROVIDER_PLASTIC_CARD_VISA |
| | | PROVIDER_PLASTIC_CARD_MASTERCARD |
| | | ALL |
| allowAdditionOfNewInstrumentInstance | | Defines the instrument types that the user can add from |
| | | the instrument manager. Must be one of: |
| | | USER_BANK_CARD |
| | | USER_BANK_ACCOUNT |
| | | PROVIDER_VIRTUAL_CARD_VISA |
| | | PROVIDER_VIRTUAL_CARD_MASTERCARD |
| | | PROVIDER_PLASTIC_CARD_VISA |
| | | PROVIDER_PLASTIC_CARD_MASTERCARD |
| allowDeletionOfInstruments | | Defines the instrument types that the user can delete from |
| | | the instrument manager. Must be one of: |
| | | USER_BANK_CARD |
| | | USER_BANK_ACCOUNT |
| | | PROVIDER_VIRTUAL_CARD_VISA |
| | | PROVIDER_VIRTUAL_CARD_MASTERCARD |
| | | PROVIDER_PLASTIC_CARD_VISA |
| | | PROVIDER_PLASTIC_CARD_MASTERCARD |
| allowViewDeleted | | Specifies whether the user is to be allowed to view details of |
| | | deleted instruments |
| allowInstrumentUpdate | | Defines the instrument types that the user can update |
| | | from the instrument manager. Must be one of: |
| | | USER_BANK_CARD |
| | | USER_BANK_ACCOUNT |
| | | PROVIDER_VIRTUAL_CARD_VISA |
| | | PROVIDER_VIRTUAL_CARD_MASTERCARD |
| | | PROVIDER_PLASTIC_CARD_VISA |
| | | PROVIDER_PLASTIC_CARD_MASTERCARD |
| selectorMode | Boolean | Specifies whether the Instrument Manager is in Selector |
| | | or View Only mode. If this value is not specified, the |
| | | Instrument Manager is in View mode. |

This tag also accepts attributes described for <payml:ewallet>:
websiteId
websiteReferralId
accountReferenceId
returnURL
CSS
outputType

The tag returns the same output as <payml:ewallet>:

1.3. Other PayML Tags

The selection of PayML tags that can be used by a website for the services provided by a payment provider are:

| PayML tag | Description |
|---|---|
| <payml:workflow-initiate-seq> | These tags allow a website to specify a sequence of processes, |
| <payml:workflow-close-seq> | each described by its corresponding PayML tag placed within a |
| | <payml:workflow-initiate-seq> and |
| | <payml:workflow-close-seq> |
| <payml:workflow-condition> | This tag allows a website to specify conditional activation of a |
| | process, depending on the value returned for an attribute taken |
| | from the PayML attributes pipeline |
| <payml:controller-owner> | This tag defines a process whereby a user of a financial |
| | instrument can issue and keep control over an instrument that is |
| | used by a separate third party. |
| | Through such process, the owner of the controlled financial |
| | instrument, can view the transactions for which the financial |
| | instrument is being used |
| <payml:controller-user> | This tag defines a process whereby a user of a financial |
| | instrument can use a financial instrument that is controlled by a |
| | separate third party. |
| | Through such process, the user can load funds and spend funds |
| <payml:issue-virtual-card> | This tag defines a process which allows an end-user to issue a |
| | virtual card, as supported by the payment provider. |
| | The <payml:instrument-manager> tag defines a more |
| | generic (but less flexible) way of how a virtual card financial |
| | instrument can be managed |
| <payml:view-virtual-card> | This tag defines a process which allows an end-user to view a |
| | virtual card, as supported by the payment provider. |
| | The <payml:instrument-manager> tag defines a more |
| | generic (but less flexible) way of how a virtual card financial |
| | instrument can be managed |
| <payml:load-virtual-card> | This tag defines a process which allows an end-user to load |
| | funds onto a virtual card through another instrument, as |
| | supported by the payment provider. |
| | The <payml:instrument-manager> tag defines a more |
| | generic (but less flexible) way of how a virtual card financial |
| | instrument can be managed |
| <payml:delete-virtual-card> | This tag defines a process which allows an end-user to remove a |
| | virtual card associated with his eWallet. |
| | The <payml:instrument-manager> tag defines a more |
| | generic (but less flexible) way of how a virtual card financial |
| | instrument can be managed |
| <payml:grouppay-organiser- | Defines a process through which a group organizer can initiate a |
| Initiate> | group payment |
| <payml:grouppay-organiser- | Defines the process through which a group organizer can |
| manage> | manage an initiated group payment |
| <payml:grouppay-payee> | Defines a process through which a group payment participant can |
| | submit, track, commit or retract a payment which has been |
| | submitted as part of a group payment |

1. A method, comprising
receiving a request from a user's device via a network at an unregulated computer system for access to financial service functionality;
transmitting a redirection instruction to the user's device;
receiving a request at a regulated computer system from the user's device, the request being transmitted from the user's device in response to the redirection instruction,
transferring data from the unregulated computer system to the regulated computer system, the data including a definition of content and markers for the insertion of content by the regulated computer system;
processing the data at the regulated computer system to add content as indicated by the markers; and
transmitting the processed data to the user's device for rendering of the data for display on that device.

2. A method according to claim 1, wherein the redirection instruction includes identification information relating to the user's device's interaction with the unregulated computer system.

3. A method according to claim 2, wherein the data transmitted from the unregulated computer system to the regulated computer system includes the identification information.

4. A method according to claim 1, wherein the markers are markup language tags.

5. A method according to claim 4, wherein the markup language tags describe an appearance of the rendered data.

6. A method according to claim 4, wherein the markup language tags describe an interaction process between the user and the regulated computer system.

7. A method according to claim 1, further comprising making selected information on the user's device's interaction with the regulated computer system available to the unregulated computer system.

8. A method, comprising
receiving a request at a regulated computer system from a user's device via a network for a page, the request including identification information;
receiving from an unregulated computer system data describing the page, the data including markers for replacement by content from the regulated computer system;
processing the data to add content as indicated by the markers; and
transmitting the processed data to the user's device for rendering of the data for display on that device.

9. A method according to claim 8, wherein the request is transmitted by the user's device in response to a redirection instruction from the unregulated computer system.

10. A method according to claim 8, wherein the markers are markup language tags.

11. A method according to claim 10, wherein the markup language tags describe the appearance of the rendered data.

12. A method according to claim 10, wherein the markup language tags describe an interaction process between the user and the regulated computer system.

13. A method according to claim 8, further comprising:
transmitting a redirection instruction from the regulated computer system to the user's device such that the user's device is redirected to the unregulated computer system.

14. A method according to claim 8, wherein the request is a first request, the method further comprising:
receiving a second request at the regulated computer system from the user's device following interaction of the user with the displayed content.

15. A method according to claim 8, further comprising:
making selected information on the user's device's interaction with the regulated computer system available to the unregulated computer system.

16. A method, comprising
receiving a request from a user's device to access financial service functionality;
transmitting a redirection instruction to the user's device to redirect that device to a regulated computer system to provide access to the functionality; and
transferring to the regulated computer system via a network data including a definition of content and markers for the insertion of content by the regulated computer system.

17. A method according to claim 16, wherein the redirection instruction includes identification information relating to the user's device's interaction with the unregulated computer system.

18. A method according to claim 16, wherein the markers relate to provisioning of financial services to the user via the regulated computer system and the user's device.

19. A method according to claim 16, further comprising:
accessing, by the unregulated computer system, selected information on the user's device's interaction with the regulated computer system, the selected information being stored by the regulated computer system.

20. A method according to claim 19, wherein the selected information is identified by the identification information.
